(19) United States
(12) Patent Application Publication
(10) Pub. No.: US 2016/0136480 A1
(43) Pub. Date: May 19, 2016

(54) SYSTEMS AND METHODS FOR WIRELESSLY INDICATING STRIKE/BALL TO A HOME PLATE UMPIRE OF A BASEBALL GAME

(71) Applicant: Verna IP Holdings, LLC, Albuquerque, NM (US)

(72) Inventors: Anthony F. Verna, Palm Desert, CA (US); Luis M. Ortiz, Albuquerque, NM (US)

(21) Appl. No.: 14/943,158

(22) Filed: Nov. 17, 2015

Related U.S. Application Data
(60) Provisional application No. 62/080,558, filed on Nov. 17, 2014.

(51) Int. Cl. A63B 24/00; H04N 7/18; G06K 9/00; G06F 17/30; H04N 5/44; G06T 7/20; H04L 29/08; A63B 71/06; G06T 7/00

(52) U.S. Cl. CPC A63B 24/0021; A63B 71/0605; H04N 7/181; G06K 9/00724; G06T 7/004; H04N 5/44; G06T 7/20; H04L 67/12; H04L 67/10; G06F 17/30256; A63B 2024/0034; G06T 2207/30224

(57) ABSTRACT

Home plate umpire call accuracy can be improved using strike zone images captured by more than one camera deployed at more than one perspective of a home plate during a baseball game. Strike zone images can be analyzed to determine if a thrown pitch is a strike or a ball. A signal can be wirelessly transmitted to a signal indicator worn by the home plate umpire to indicate if the pitch was a strike or a ball in order to assist the umpire in making a call. The sent signal can cause the signal indicator to make different a noise, visual indication (e.g., light), or haptic feedback sensation depending on whether the pitch was a strike or a ball.

### INVENTION PRIORITY

This patent application claims the benefit under 35 U.S.C. §119(e) of U.S. Provisional Application 62/080,558, entitled “SYSTEMS AND METHODS FOR WIRELESSLY INDICATING STRIKE/BALL TO A HOME PLATE UMPIRE OF A BASEBALL GAME,” which was filed on Nov. 17, 2014 and is incorporated herein by reference in its entirety.

### FIELD OF THE INVENTION

The present invention is generally related to strike zone imaging technology as used in professional baseball for post-game analysis, post play challenges, and entertainment. More particularly, the present invention is related to systems and methods to improve home plate umpire call accuracy in baseball by analysis strike zone imaging data for “strike” or “ball” determination and wirelessly transmitting the determination to home plate umpires to assist in making a call.

### BACKGROUND

Bad home plate umpire calls in professional baseball have really become a serious concern. In baseball, the “strike zone” is that area over home plate the upper limit of which is a horizontal line at the midpoint between the top of the shoulders and the top of the uniform pants, and the lower level is a line at the bottom of the knees. The strike zone should be determined from the batter's stance as the batter is prepared to swing at a pitched ball. Imaging processing technology is used today to identify the strike zone during baseball games. The technology generally involves complex systems that fuse high-end computer graphics with a sophisticated algorithm for calculating flight trajectories up to travel termination in a catcher's glove. ESPN, for example, has created “K Zone”, which is a pitch-tracking system using computer-generated graphics to create a shaded, translucent box that outlines the strike zone boundaries for viewers. Behind the flashy graphics, K Zone provides a sophisticated computing subsystem that monitors each pitch's trajectory. Its development model may well prove effective in future computer vision projects, regardless of its current application domain.

Since being introduced in 2014 at Major League Baseball (MLB) games in the United States, Instant Replay Reviews have been a huge success, overturning half the umpire calls—and in ultimately deciding the outcome of a game. But there is still an officiating problem in baseball associated with the plate umpire making the wrong call over 10 percent of the time and sometimes causing a win or lose of an important game; yet plate calls still remain unchallengeable despite the implementation of instant replay. This problem resulted in the 2014 World Series umpires being picked on how well they called plays and balls/strikes.

The Zone Evaluation system (also referred to as “Z-E Score”) was put in every park in 2009 to replace QuesTec, and it measures practically every pitch called by an umpire; with batted balls discarded. Cameras record the pitch in flight more than 20 times before it reaches the plate. The predecessor, QuesTec, was known for its Umpire Information System (UIS), which was used by MLB for the purpose of providing feedback and evaluation of Major League umpires. Z-E score replaced QuesTec because of its improved accuracy. The UIS system consisted of four cameras placed around a ballpark that feed into a computer network and record the locations of pitches throughout the course of a game. Two of the cameras were located high in the stands above the 1st and 3rd base lines to track the trajectory of each pitch. The other two were located at field level and record the stance of the batter so the top and bottom of the strike zone can be set. Computer software then generated recordings that umpires and MLB executives could review and learn from. The recorded data include video of the pitches as well as graphic representations of their locations plus feedback on the umpires' accuracy.

In a 2014 article entitled “Rung Up: Are Postseason Umpires Actually Baseball's Most Accurate?” staff writer Ben Linderbough of Grantland (which is a popular sports and pop-culture blog started by veteran writer and sports journalist Bill Simmons in 2011, and is indirectly associated with ESPN) describes how MLB's postseason umpire selection system is supposed to minimize those umpire mistakes with the main component in the selection of umpires for postseason assignments being performance during the season. MLB factors in results from the Zone Evaluation system for their plate assignments, accuracy on their calls and rulings, and observations of their work by our Supervisory staff. In addition, there is consideration given to an Umpire's experience level (overall seniority and previous Postseasons), his proficiency at handling situations, health and time missed during the season, and a number of other administrative factors. Linderbough's research findings, however, reveal that there has not been an improvement in umpire calls despite MLB's efforts.

With assistance from Daren Willman, proprietor of invaluable advanced-stats resource Baseball Savant, Linderbough examined umpire correct-call rates from 2009 to 2014, all of which fell into a narrow band between the lower limits of MLB's tolerance for idiosyncratic strike zones and the upper limits of the human sensory system. Linderbough and William looked for evidence of increased October umpire quality with data from PITCHf/x, Major League Baseball Advanced Media's pitch-tracking technology. Willman classified strikes on called pitches outside the dimensions of the rulebook strike zone and balls on called pitches inside the zone as incorrect calls. Balls on called pitches outside the zone and strikes on called pitches inside the zone were designated as correct calls. Each umpire's correct-call rate is simply his tally of correct calls divided by all of his calls. Among the 79 umpires who called at least 3,000 pitches during the 2014 regular season, the difference between the most accurate (Lance Barksdale, 88.6 percent correct calls) and the least accurate (Brian O'Nora, 84.2 percent) was only 4.4 percentage points. Because full-time umps can call several thousand pitches in a season, though, minor differences in accuracy add up: the gap between Barksdale and O'Nora translates to 193 incorrect calls over the course of a typical umpire's season, or roughly seven per full game behind the plate (which would, on average, be distributed evenly between teams). Most umpires, however, are clustered so closely together that you'd have a hard time telling the good from the bad by watching.

Linderbough found that roughly one-third of umpires who call games from behind the plate during the regular season also do so during the postseason. The following table created by Linderbough compares the regular-season accuracy of postseason umps to the regular-season accuracy of all umps:

| Year | All Umps | Postseason Umps Only |
|---|---|---|
| 2009 | 84.8 percent | 84.8 percent |
| 2010 | 85.6 | 85.3 |
| 2011 | 85.9 | 85.7 |
| 2012 | 86.2 | 86.0 |
| 2013 | 86.8 | 86.6 |
| 2014 | 86.7 | 86.5 |
| Total | 86.0 | 85.8 |

In his article in Grantland, Linderbough states [I]f the best ball/strike-callers are being picked for the postseason, the accuracy of the ‘postseason only’ group should be above the league average. Clearly, MLB has not yet improved home plate umpire accuracy given its umpire selection system.

What are needed are systems and methods that can improve home plate umpire call accuracy. One of the present inventors is Tony Verna, who is well known for introducing instant replay for the very first time over fifty years ago in the 1963 game between the U.S. Army and U.S. Navy academy teams. Tony Verna believes that accuracy in home plate ball/strike calls could be substantially improved by implementing the present invention.

### SUMMARY OF THE INVENTION

In light of the foregoing limitation in the current state of the art, what is presented herein are systems and method for improving baseball game home plate umpire call accuracy.

Accordingly, it is a feature of the present invention to provide a system that can capture images of baseball pitches from more than one perspective, determine a strike zone, analyze whether a pitch is within or outside of the strike zone, transmit a signal representing the determination whether the pitch was a strike or a ball to a signal indicator worn by the home plate umpire.

It is another feature of the present invention wherein the signal can be presented in the form of an audio signal as a single beep indicating a “strike” and two beeps indicating a “ball.”

It is yet another feature of the present invention wherein the signal can be presented in the form of a visual signal where a first light located on the umpire's facemask indicates a “strike”, while a second light located on the umpire's mask indicates a “ball.”

It is then another feature of the present invention wherein the signal can be presented in the form of a tactile signal wherein a first transducer is located on the umpire's facemask or headband in contact with a first location of an umpires face or head indicates a “strike”, while a transducer located on the umpire's mask or headband in contact with a second location of the umpire's head or face indicates a “ball.”

It is yet another feature of the present invention that the signal be transmitted directly to the umpire via dedicated and secure wireless communication to expedite timing and minimize signal interference.

It is yet another feature of the present invention that the system strike zone determinations and actual umpire calls be tracked and stored for use in post call challenges assessments and statistical archiving.

These and other features will be apparent to those skilled in the art upon reviewing the detailed description and drawings.

### SUMMARY OF THE DRAWINGS

FIG. 1 illustrates a system in accordance with features of the present invention;

FIG. 2 illustrates a flow diagram of a method in accordance with features of the present invention;

FIG. 3 illustrates a flow diagram of another method in accordance with features of the present invention; and

FIG. 4 illustrates an umpire mask in accordance with features of the present invention.

### DETAILED DESCRIPTION OF EMBODIMENTS

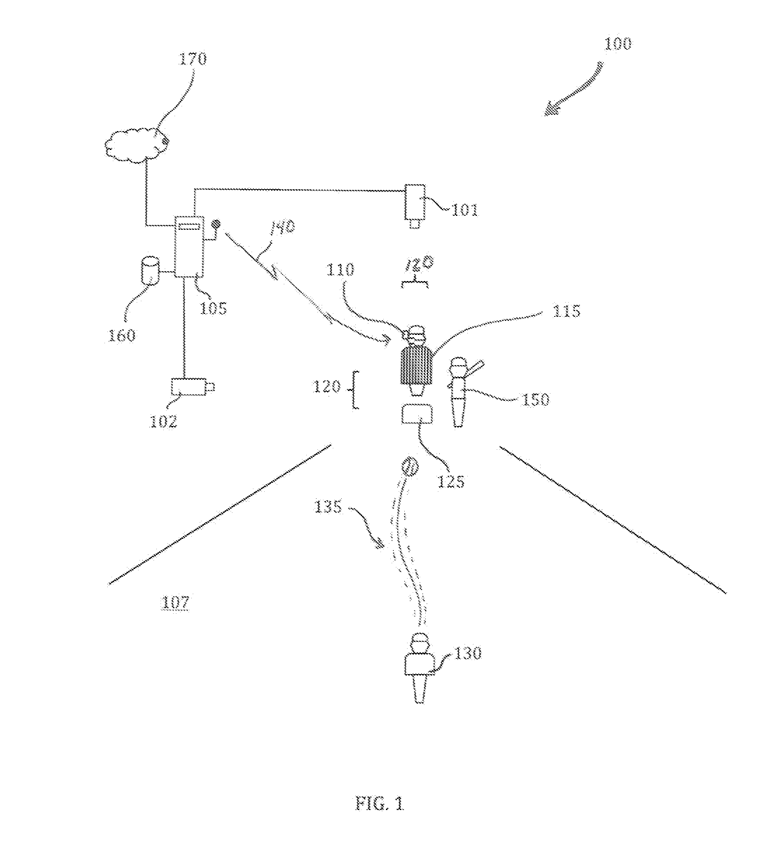

FIG. 1 illustrates a system 100 in accordance with features of the present invention including at least two cameras 101/102 deployed at a baseball field 107 capturing images from different perspective of a strike zone 120 established area over a home plate 125 during a baseball game. The images are then provided by the cameras 101/102 to a computer 105, wherein the images are processed to determine whether a pitch 135 thrown by a pitcher 130 towards the strike zone 120 is a strike or a ball. The determination is made after the computer 105 has first established the parameters of the strike zone 120 based on images capture by the cameras 101/102 of a batter 150 standing at the home plate 125. Once the computer 105 determines whether a pitch 135 is a strike or ball, it wirelessly transmits a signal 140 to a signal indicator 110 worn by a home plate umpire 115 responsible for making pitch calls. The signal 140 can be presented in various forms. One suggestion is that a signal 140 be provided in the form of an audio signal to an earphone as the signal indicator 110, and that the signal representing a single beep be transmitted to represent that a “strike” has been thrown by the pitcher, or an audio signal representing two beeps can be transmitted as the signal 140 to the earphone to represent that a “ball” has been thrown by the pitcher 130. The home plate umpire 115 can then make the ultimate verbal and official call for the pitch 135, regardless of the form of the audio signal 140.

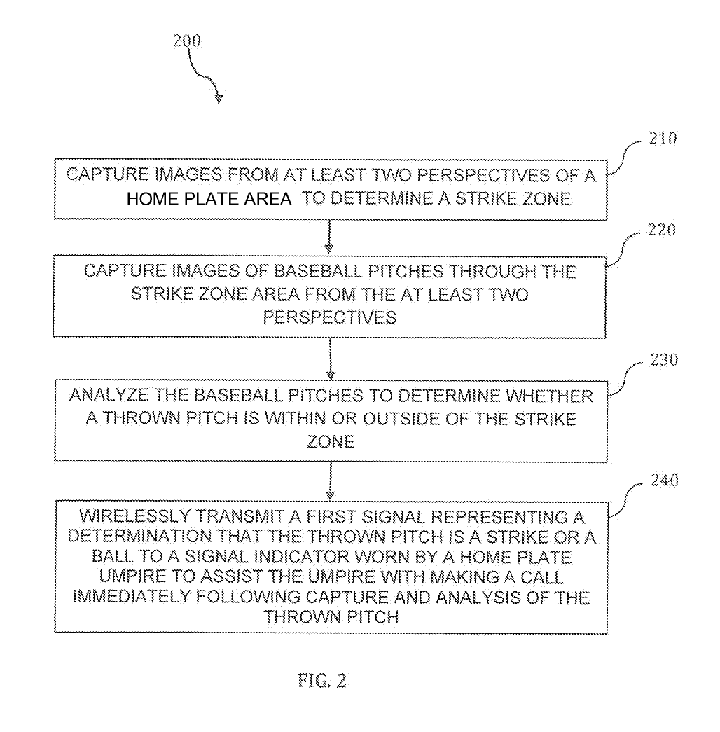

Referring to FIG. 2, a flow diagram 200 of a method in accordance with features of the present invention is shown. Referring to block 210, images from at least two perspectives of a home plate area are captured by cameras to determine a strike zone. In block 220, images of baseball pitches through a strike zone area from more than one perspective area is captured by the cameras. As shown in block 230, pitches are analyzed to determine whether a pitch is within or outside of the strike zone. Then as shown in block 240, a signal representing the determination of whether a pitch is a strike or a ball is wirelessly transmitted to a signal indicator worn by a home plate umpire to assist the umpire with making a call immediately following a pitch.

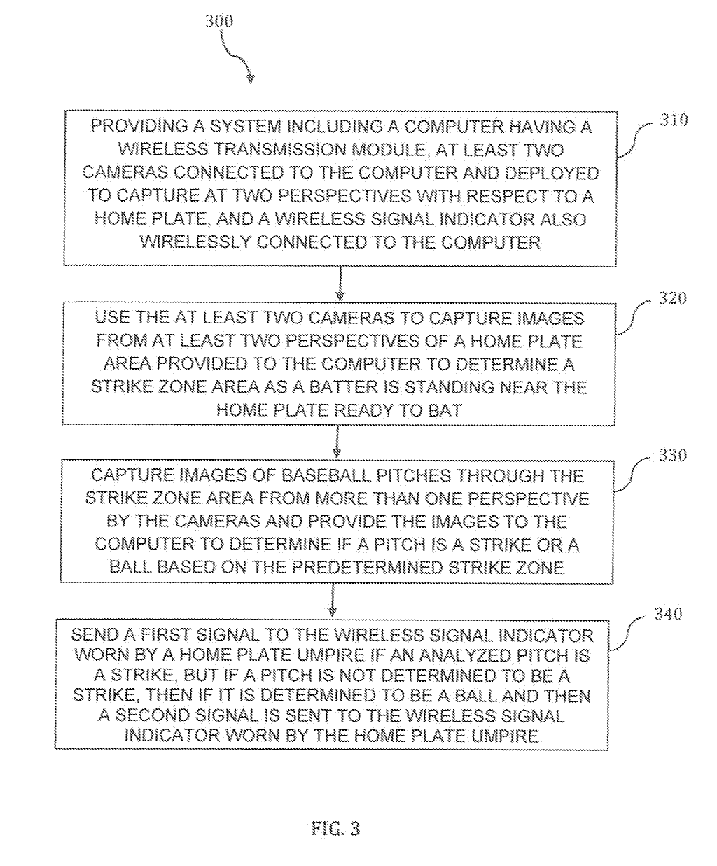

Referring to FIG. 3, a flow diagram 300 of a method in accordance with features of the present invention is shown. Referring to block 310, a system including a computer having wireless transmission module, at least two cameras deployed to capture at least two perspectives with respect to a home plate connected to the computer, and a wireless signal indicator connected to the computer is provided. As shown in block 320, the at least two cameras are used to capture images from at least two perspectives of a home plate area and are provided to the computer to determine a strike zone area as a batter is standing near the home plate ready to bat. In block 330, images of baseball pitches through a strike zone area are captured from more than one perspective by the cameras and are provided to the computer to determine if a pitch is a strike or a ball based on the predetermined strike zone. As shown in block 340, a first signal is sent to the wireless signal indicator worn by a home plate umpire if an analyzed pitch is a strike. If a pitch is not determined to be a strike, then if it is determined to be a ball, a second signal is sent to the wireless signal indicator worn by the home plate umpire as shown in block 340. The first or second signal assists the umpire in making a strike or ball call for each pitch analyzed by the computer.

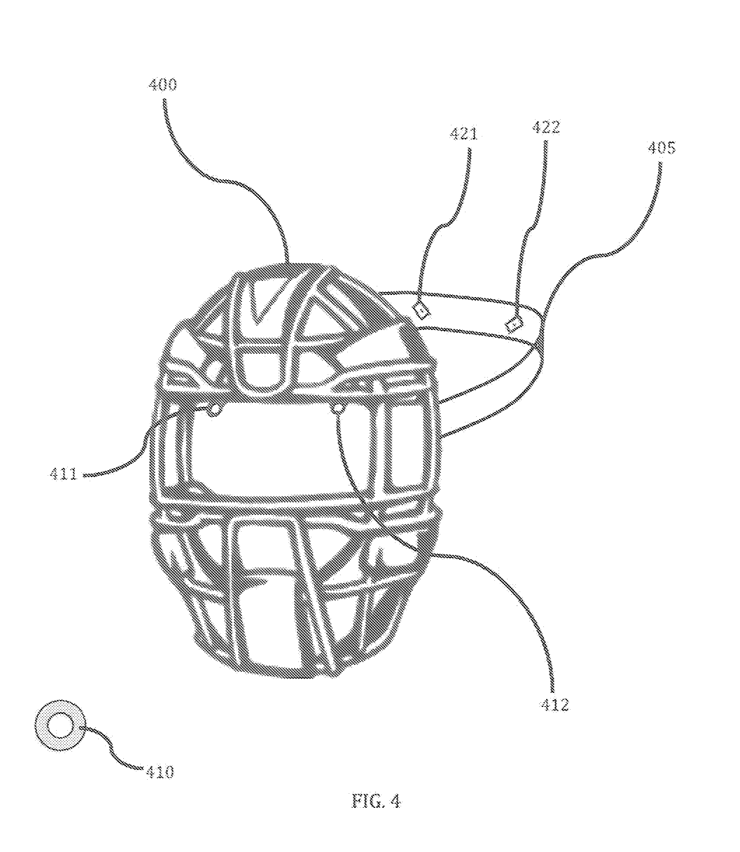

Referring to FIG. 4, an illustration of an umpire facemask 400 is shown. The signal sent to the umpire can be provided in the form of an audible signal to a wireless earphone 410, such as a beep. In this case, a single beep can represent that the pitch was a strike, while a double beep can represent that the pitch was a ball. It should also be appreciated that the signal could also be wirelessly provided in the form of a light signal. In this case, a first led light 411 affixed to, for example, the right side of an umpire's facemask could light up if the pitch was a strike, or a second led light 412 affixed to the left side of an umpires facemask could light up if the pitch was determined to be a ball. It should also be appreciated that a single light can be used, and the signal can be a single flash for strike and multiple flashes for ball, or any other pattern suitable to indicate the difference between strike and ball assessments by the computer.

Vibration transducers could also be used to indicate the first and second signal. Haptic technology, or haptics, is a tactile feedback technology, which recreates the sense of touch by applying forces, vibrations, or motions to the user. Mechanical stimulation is generally enabled by actuators that apply forces to the skin. Such actuators provide mechanical motion in response to an electrical stimulus. For example, a first vibration transducer 421 can be integrated with the protective face mask or strapping 405 on the right side of the umpires face/head and can indicate a strike, while a second vibration transducer 422 can be integrated with the face mask or strapping on the left side of the face mask and can indicate a ball. As with the light example, a single transducer could be used so long as different signaling patterns are also used to distinguish between strikes and balls. It should be appreciated that other forms of hardware for providing signal indications can be used without departing from the notification aspects of the present invention, which are key to increasing home plate calling accuracy.

The image processing software can be also be programmed to detect if there is ball deflection (tip) caused by a bat that was swung by a batter or if the ball is hit out of bounds. If so, the system can count it as a strike up to two strikes, then begin counting deflections/foul balls as balls. Signals can be indicating to the home plate umpire accordingly.

Referring again to FIG. 1, a database 160 and data network connection 170 is shown in the system. In addition to providing dedicated wireless signaling to a home plate umpire, the database can be used to record data (e.g., video and strike/ball determinations). The data can be accessed via the network 170 for use by statisticians, team owners and managers, producers, broadcasters, and service subscribing fans. The data can also be accessed for use in post call challenges (e.g., instant replay review), to improve umpire and batter performance, and for entertainment purposes.

Although a network 170 is shown for the system 100 in FIG. 1, it is preferred that the signal used to assist the umpire making live calls during a game be transmitted directly to the umpire from the computer via dedicated and secure wireless communications supported by a wireless module to expedite timing and minimize signal interference.

The earphone can be provided in a number of form factors. For example, there are many wireless headphone designs utilizing Bluetooth for secure communication with sending devices such as mobile phones. There are already headphones used in professional sports. For example, Bose™ provides headphones for the National Football League (NFL) in the form of a singular, lightweight, wireless, noise canceling, around-ear, aviation headphone. The same type of headphone could be fitted securely alongside one side of the home-plate umpire's face mask and be capable of receiving a point-to-point, isolated VHF band unidirectional, audio feed. The audio can be transmitted with an encryption algorithm for secure transmission, and resistant to both hardware and software-centric systems attacks. The headphone can be activated by encrypted and decrypted password-input and can be fed through a tangled-free cable, plugged into a portable, bodypack receiver powered by an internal Lithium-ion or 9V battery with a volume control knob and on/off switch.

Wireless transmission hardware should be selected so that transmission of a signal to a home plate umpire is not delayed. Unlike the transmission of data to parties via network 170 where delay is not as significant, network delays could prevent an umpire from quickly, seamlessly making a call within a couple of seconds of a pitch being received by a catcher. Data network delays can create a lag that would prevent the umpire from benefitting from the processed strike/ball assessment of the computer. Image capture, processing, and signal transmission should be as close to real-time as possible, and given the speeds of image capture, processing and signal transmission by computer today that is available today, there should not be an unreasonable delay in getting a computer generated pre-call to the home plate umpire so that call accuracy can hopefully be increased in future baseball games.

It should be appreciated that the system and methods described herein can be provided as an improvement to, and configured for adaptation of, current imaging system being used to display ball placement in the strike zone during baseballs games. The improvement described herein could be added to, for example, the K-Zone and ZE Zone systems described in the background of the present specification and which lack real time umpire signaling capabilities to indicate strikes/balls in order to improve umpire calls.

1. A system for improving baseball game home plate umpire call accuracy, comprising:
at least two cameras deployed at different perspective of a home plate in a baseball field for capturing images from at least two perspectives of the home plate area;
a computer connected to the at least two cameras, said computer determining a strike zone and analyzing pitches based on data from the at least two perspectives of the home plate area to determine if a thrown pitch is a strike or a ball; and
a wireless module transmitting signals to a signal indicator worn by a home plate umpire to inform the umpire if a thrown pitch is a strike or ball immediately following capture and analysis of the thrown pitch.

2. The system for improving baseball game home plate umpire call accuracy of claim 1, further comprising a database for storing captured and analyzed data.

3. The system for improving baseball game home plate umpire call accuracy of claim 1, further comprising a data network connection for enabling access to third parties.

4. The system for improving baseball game home plate umpire call accuracy of claim 1, further comprising a secured, dedicated wireless transmission module in communication with the signal indicator worn by the home plate umpire.

5. The system for improving baseball game home plate umpire call accuracy of claim 1, wherein said signal indicator provides at least one of: an audio signal, a light signal, or a haptic feedback signal.

6. The system for improving baseball game home plate umpire call accuracy of claim 3, further comprising a secured, dedicated wireless transmission module in communication with the signal indicator worn by the home plate umpire.

7. The system for improving baseball game home plate umpire call accuracy of claim 3, wherein said signal indicator provides at least one of: an audio signal, a light signal, or a haptic feedback signal.

8. A method for improving baseball game home plate umpire call accuracy, comprising:
capturing images from at least two perspectives of a home plate area to determine a strike zone;
capturing images of baseball pitches through the strike zone area from the at least two perspectives;
analyzing the baseball pitches to determine whether a thrown pitch is within or outside of the strike zone; and
wirelessly transmitting a first signal representing a determination that the thrown pitch is a strike or a ball to an a signal indicator worn by a home plate umpire to assist the umpire with making a call immediately following capture and analysis of the thrown pitch.

9. The method for improving baseball game home plate umpire call accuracy of claim 8, further comprising storing captured and analyzed data in a database.

10. The method for improving baseball game home plate umpire call accuracy of claim 8, further comprising providing third party access to captured and analyzed data from said database via a data network connection to a computer analyzing said captured and analyzed data.

11. The method for improving baseball game home plate umpire call accuracy of claim 8, further comprising providing signals indicating strike or ball to the signal indicator worn by the home plate umpire via a secured, dedicated wireless transmission module in communication with the signal indicator.

12. The method for improving baseball game home plate umpire call accuracy of claim 8, wherein said signal is provided to the signal indicator as at least one of: an audio signal, a light signal, or a haptic feedback signal.

13. The method for improving baseball game home plate umpire call accuracy of claim 10, further comprising providing third party access to captured and analyzed data from said database via a data network connection to a computer analyzing said captured and analyzed data.

14. The method for improving baseball game home plate umpire call accuracy of claim 11, wherein said signal is provided to the signal indicator as at least one of: an audio signal, a light signal, or a haptic feedback signal.

15. A method for improving baseball game home plate umpire call accuracy, comprising:
provide a system including a computer having wireless transmission module, at least two cameras deployed to capture at least two perspectives with respect to a home plate connected to the computer and a wireless signal indicator connected to the computer;
use at least two cameras that are used to capture images from at least two perspectives of a home plate area provided to the computer to determine a strike zone area as a batter is standing near the home plate ready to bat;
capture images of baseball pitches through a strike zone area from more than one perspective by the cameras providing the images to the computer to determine if a pitch is a strike or a ball based on the predetermined strike zone; and
send a first signal to the wireless signal indicator worn by a home plate umpire if an analyzed pitch is a strike, but if a pitch is not determined to be a strike, then if it is determined to be a ball and a second signal is then sent to the wireless signal indicator worn by the home plate umpire.

16. The method for improving baseball game home plate umpire call accuracy of claim 15, further comprising storing captured and analyzed data in a database.

17. The method for improving baseball game home plate umpire call accuracy of claim 15, further comprising providing third party access to captured and analyzed data from said database via a data network connection to a computer analyzing said captured and analyzed data.

18. The method for improving baseball game home plate umpire call accuracy of claim 15, further comprising providing signals indicating strike or ball to the signal indicator worn by the home plate umpire via a secured, dedicated wireless transmission module in communication with the signal indicator.

19. The method for improving baseball game home plate umpire call accuracy of claim 15, wherein said signal is provided to the signal indicator worn by the home plate umpire as at least one of: an audio signal, a light signal, or a haptic feedback signal.

20. The method for improving baseball game home plate umpire call accuracy of claim 18, further comprising providing third party access to captured and analyzed data from said database via a data network connection to a computer analyzing said captured and analyzed data.
